(19) United States
(12) Patent Application Publication
(10) Pub. No.: US 2013/0104996 A1
(43) Pub. Date: May 2, 2013

(54) METHOD FOR BALANCING GAS FLOW SUPPLYING MULTIPLE CVD REACTORS

(71) Applicants: JEONGHOON OH, San Jose, CA (US); Michael S. Cox, Gilroy, CA (US); Alexander S. Polyak, San Jose, CA (US)

(72) Inventors: JEONGHOON OH, San Jose, CA (US); Michael S. Cox, Gilroy, CA (US); Alexander S. Polyak, San Jose, CA (US)

(73) Assignee: APPLIED MATERIALS, INC., Santa Clara, CA (US)

(21) Appl. No.: 13/647,160

(22) Filed: Oct. 8, 2012

Related U.S. Application Data
(60) Provisional application No. 61/551,603, filed on Oct. 26, 2011.

(51) Int. Cl. F16K 11/00

(52) U.S. Cl. CPC F16K 11/00
USPC 137/2; 137/861

(57) ABSTRACT

Gas supply systems and methods are disclosed for solar cell production using multiple parallel reactors. A first gas supply control system has a gas panel having a plurality of gas outlet lines, supplying a first main supply line having a main line mass flow meter measuring the combined total gas mass flow rate in the first main supply line. First, second and third branch lines supplied by the first main supply line each branch line having mass flow controller and one or more control loops established between the mass flow meter and the branch line mass flow controllers. The control loop determining a set point for each of the branch mass flow controllers based on dividing the flow rate of the total gas flow by the number of reactors in use. In addition, a second gas supply control system may be coupled to the first gas supply control system to avoid mixing certain gases before they enter the respective reactors to which they are supplied.

### CROSS-REFERENCE TO RELATED APPLICATION/PRIORITY CLAIM

This application claims the benefit of U.S. Provisional Application No. 61/551,603, filed on Oct. 26, 2011, which is herein incorporated by reference in its entirety.

### BACKGROUND OF THE INVENTION

1. Field of the Invention

The present invention generally relates to methods and apparatuses for gas delivery systems and control of gas delivery to multiple semiconductor processing chambers, such as chemical vapor deposition reactors.

2. Description of the Related Art

In processing semiconductor substrates, it may be desirable to operate multiple reactors at the same time. For example, multiple reactors may simultaneously run chemical vapor deposition (CVD) processes to increase the overall throughput of processed devices, such as crystalline silicon solar cells and thin film solar cells. In batch reactor processes, gas delivery systems have been difficult to configure and adjust to create multiple reactors that operate with identical or substantially identical process conditions as determined by subsequent quality evaluations. When the mass flow rates of gas constituents vary unpredictably between processing chambers, the substrates resulting from such processes must be individually measured to evaluate whether the actual substrate transformation (layer deposition or removal) meets the quality standards for process that has taken place in each reactor chamber. In batch parallel process chambers, making the assumption that processes taking place in adjacent parallel substrate processing reactors match each has not been supported by subsequent evaluation of the substrates processed. A process gas supply piping (line) configuration using multiple mass flow controllers, one for each gas prescribed for a reactor process, and adjusting the gas flow rate individually in each supply line has been an acceptable though burdensome solution to achieve identical or nearly identical process gas flow rates. Each individual processing chamber's gas supply control has utilized a separate “gas panel” containing multiple gas mass flow controllers which have been individually adjusted to achieve the desired statistically acceptable identical (within the range of process specification requirements) result.

FIG. 1 illustrates a conventional gas supply system, in which each of three reactors 10, 20, 30 has a separate gas panel 40, 50, 60, respectively, configured to supply selected process gases directly to only one reactor (or a substrate processing chamber). This configuration allows process control of each reactor, but requires multiple arrangements of (gas) mass flow controllers (MFCs), fittings and valves for the multiple gas panels and reactors. For example, gas panel 40 includes four separate gas inlet lines 41, 42, 43 and 44, which each require separate MFCs or mass flow rate meter (MFM) assemblies 45, 46, 47 and 48, to supply a selected amount of a specific process gas or blend of gases into piping 49. Piping 49 combines and routes the gases into a showerhead 11 to feed into a reactor 10.

In an effort to reduce complexity and simplify the adjustment steps needed to achieve the goal of identical process conditions in side by side batch process reactors, past approaches have tried throttling the combined outlet flow from a single gas panel by installing fixed orifices or adjustable needle valves to balance and manage flow to multiple reactors. However, due to frequent changes in process conditions (such as gas flow rates, pressures, temperatures, etc.) and installation and mechanical wear variations in the gas supply piping to each reactor as compared to any other reactor, the attempted static methods of adjusting the mass flow rate to one reactor to match other similarly configured and situated reactors in multiple batch reactor configurations have not been successful.

Therefore, a need exists to reduce the complexity and improve matching of gas mass flow rates to process reactors in multiple reactor batch configurations which are utilized to make substrate based devices, such as solar cells.

### SUMMARY OF THE INVENTION

Apparatuses and methods for controlling gas flow to multiple reactors are provided. These approaches to controlling gas flow may be used in the production of solar cells, such as by a chemical deposition process. In one embodiment, a first gas supply system for multiple substrate processing chambers is provided, comprising: one or more gas supply lines configured to supply one or more process gases to multiple reactors; a main supply line supplied by the one or more gas lines; a main supply line mass flow measuring device positioned to measure a parameter indicative of total mass flow rate of the one or more process gases in the main supply line; a series of branch lines supplied by the main supply line, wherein at least one branch line supplies the one or more process gases to each reactor; and a series of branch line mass flow controllers, wherein there is at least one mass flow controller positioned to control the mass flow of the one or more process gases through each branch line according to one or more set points derived from the measured parameter of the main supply line mass flow measuring device.

In another embodiment, the one or more gas supply lines comprises a first plurality of gas supply lines that is each configured to supply a process gas such that a plurality of process gases are available to be delivered to the multiple reactors. In yet another embodiment, a gas panel supplies the first plurality of gas supply lines. In a further embodiment, a common manifold supplied by the first plurality of gas supply lines and supplying the main supply line, wherein the first plurality of process gases are combined in the common manifold into a total gas flow in the main supply line; and a splitting manifold supplied by the main supply line, wherein the total gas flow of the first plurality of process gases is split about equally to supply each of the branch lines. In another embodiment, a series of showerheads is provided such that one showerhead is contained within each reactor that is supplied by at least one branch line, wherein the multiple reactors are chemical vapor deposition reactors configured to operate in parallel.

In yet another embodiment, the main supply line mass flow measuring device comprises a mass flow meter that determines the total mass flow rate, and the one or more set points for the branch line mass flow controllers are determined by dividing the total mass flow rate by the number of reactors being fed from the series of branch lines. In further embodiments, one or more control loops are established between the main supply line mass flow measuring device and the branch line mass flow controllers. In additional embodiments, the one or more set points are determined by dividing the total gas flow by either the number of reactors, or the number of branch lines or the number of mass flow controllers. In a further embodiment, there are three reactors, and the number of branch lines and the number of mass flow controllers are equal to the number of reactors. In a still further embodiment, there are four reactors.

In another embodiment, a second gas supply system is set up to feed one or more additional process gases to the multiple reactors being fed by the first gas supply system, without mixing a second set of the one or more additional process gases from the second gas supply system with the one or more process gases from the first plurality of gas supply lines, wherein the second system comprises: one or more secondary gas supply lines configured to supply the second set of one or more of the additional process gases to the multiple reactors; a secondary main supply line supplied by the one or more secondary gas supply lines; a secondary flow measuring device configured and positioned to measure a secondary total mass flow in the secondary main supply line; a series of secondary branch lines supplied by the secondary main supply line, wherein at least one secondary branch line supplies gas flow to each of the multiple reactors; and a series of secondary branch line mass flow controllers, wherein at least one secondary flow controller controls the mass flow to each of the series of secondary branch lines according to a secondary set point determined by dividing the mass flow measured by the secondary mass flow measuring device and dividing it by the number of reactors being fed by the series of secondary branch lines.

In a different embodiment, a gas supply control system is provided for multiple parallel chemical vapor deposition reactors, comprising at least a first gas supply system comprising: a gas panel having a plurality of gas outlet lines, wherein each gas outlet line is configured to supply one of a plurality of process gases to multiple reactors; a main supply line supplied by the plurality of gas outlet lines, forming a combined total gas flow; a mass flow meter positioned to measure a combined total gas flow rate of the combined total gas flow in the main supply line; a first, a second and a third branch line, each supplied by the main supply line; a first branch mass flow controller controlling the mass flow rate in the first branch line, the first branch line supplying a first reactor of the multiple reactors, a second branch mass flow controller controlling the mass flow rate in the second branch line supplying a second reactor of the multiple reactors, and a third branch mass flow controller controlling the mass flow rate in the third branch line supplying a third reactor of the multiple reactors; and one or more control loops established between the main supply line mass flow meter and the first, second and third branch mass flow controllers.

In a further embodiment, the control loop is wired to determine a set point for each of the first, second and third branch mass flow controllers based on dividing the combined total gas flow rate by the number of reactors in use, and further comprising a computer control unit. In a still further embodiment, the gas supply control system further comprises a fourth branch line supplied by said main supply line; and a fourth branch mass flow controller controlling the mass flow rate in the fourth branch line supplying a fourth reactor of the multiple reactors, wherein a control loop is established between the main line mass flow meter and the fourth branch mass flow controller.

In another embodiment, the gas supply control system further comprises: a second gas supply system comprising: one or more secondary gas outlet lines configured to supply one or more secondary process gases, respectively; a secondary main supply line supplied by the one or more secondary gas outlet lines, forming a total combined secondary gas flow; a secondary main supply line mass flow meter measuring a secondary main supply line mass flow rate of the total secondary gas flow; first, second, third and fourth secondary branch lines supplied by said secondary main supply line; a secondary first branch mass flow controller controlling the mass flow rate in the secondary first branch line supplying the first reactor of said multiple reactors, a secondary second branch mass flow controller controlling the mass flow rate in the secondary second branch line supplying the second reactor of a said multiple reactors, and a secondary third branch mass flow controller controlling the mass flow rate in the secondary third branch line supplying the third reactor of said multiple reactors, a secondary fourth mass flow controller controlling the mass flow rate in the secondary fourth branch line supplying the fourth reactor of said multiple reactors; and one or more control loops established between the secondary main supply line mass flow meter and the secondary first, second, third and fourth mass flow controllers.

In other embodiments, a method is provided for controlling the flow of process gases to multiple parallel reactors used for solar cell production, comprising the steps of: supplying one or more process gases to a piping assembly, wherein the piping assembly is arranged so that, when more than one of the process gases are supplied, the plurality of process gases are combined; measuring a total gas flow rate of the combined process gases, by using a total gas mass flow meter; approximately equally splitting the total gas mass flow rate into three or more branch gas supply lines by operating a control system that uses the signal generated by the total gas mass flow meter to determine a set point for each of multiple branch supply line gas mass flow rate controllers, wherein the total mass gas flow rate is split into multiple separate gas streams of approximately equal amounts, and each of the separate branch supply gas streams is controlled by one of the multiple branch gas mass flow rate controllers to regulate the gas mass flow rate fed into one of multiple parallel reactors; and operating each of the multiple parallel reactors.

In some embodiment, the method may further comprise the step of operating each of the multiple parallel reactors comprises conducting a chemical vapor deposition process on solar cells within the multiple reactors. In a still further embodiment, four reactors are operated.

In yet another embodiment, the method further comprises the steps of: supplying one or more additional process gases into an additional piping assembly, wherein the additional piping assembly is arranged so that, when more than one of the additional process gases are supplied, the plurality of additional process gases are combined; and measuring the combined total mass flow rate and generating an additional signal representative of a total additional gas mass flow rate of the one or more additional process gases, by using an additional gas mass flow meter, wherein the step of operating the control system further comprises using the additional signal generated by the additional gas mass flow meter to determine a set point for each of multiple additional gas mass flow controllers, wherein the total additional gas mass flow coming from the mass flow meter is split into multiple separate additional branch gas streams, and each of the separate additional gas streams is supplied to one of the multiple additional gas mass flow controllers, and each of the multiple additional gas mass flow controllers regulates the flow of the additional gas stream into approximately equal amounts to supply one of multiple parallel reactors. In a further embodiment, the process gases comprise plasmas from an external plasma source.

### BRIEF DESCRIPTION OF THE DRAWINGS

So that the manner in which the above recited features can be understood in detail, a more particular description may be had by reference to embodiments, some of which are illustrated in the appended drawings. It is to be noted, however, that the appended drawings illustrate only exemplary embodiments and are therefore not to be considered limiting in scope.

FIG. 1 illustrates a schematic diagram of a conventional gas supply system using one gas supply panel for each reactor.

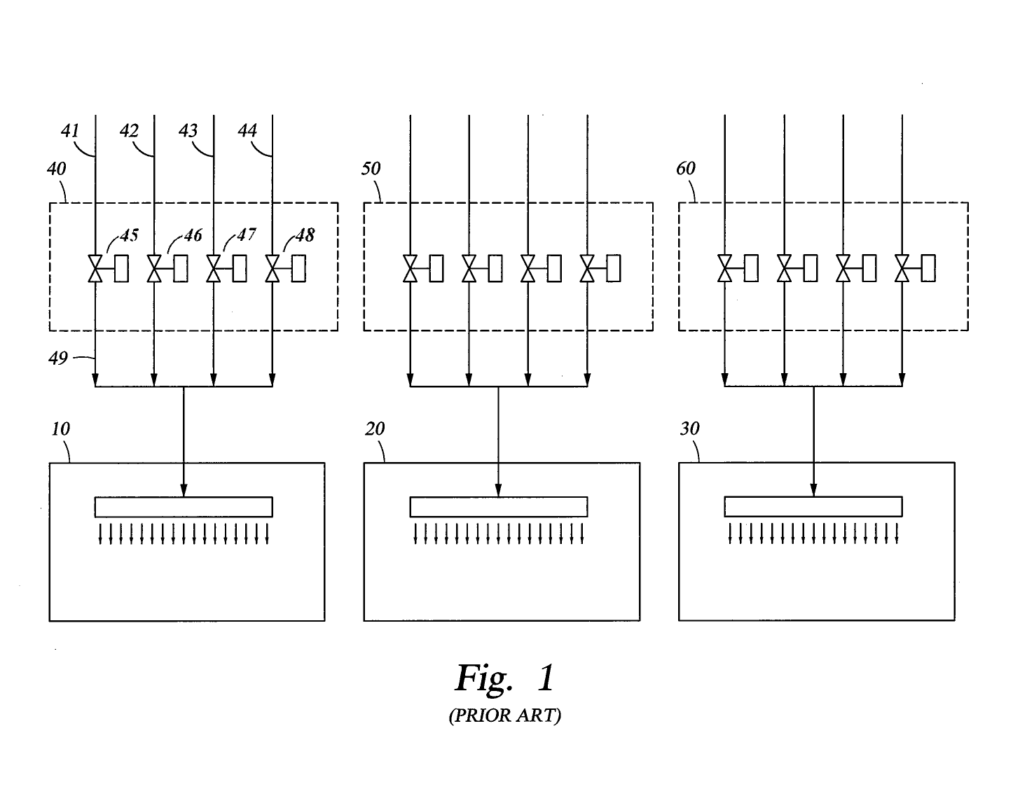

FIG. 2 illustrates a schematic diagram of a gas flow balancing branch supply system configuration, using one gas supply panel to supply multiple reactors.

It is contemplated that elements and features of one embodiment may be beneficially incorporated in other embodiments without further recitation.

### DETAILED DESCRIPTION

Embodiments discussed herein provide novel gas supply configurations for balancing (e.g., equally splitting) gas flow that is supplied to multiple reactors, and methods for balancing gas flow that is supplied to multiple reactors. Further embodiments relate to multiple CVD reactors. As used herein, the term “multiple” refers to three or more.

In some embodiments, a gas supply system is provided in which one or more process gases are directed to a flow meter, and then split into multiple branch gas streams, with each branch gas stream (supply) directed to one of multiple substrate processing chambers. A series of flow controlling devices (such as control valves or mass flow controllers) may be provided such that each flow controlling device controls the flow rates for each of the multiple branch gas streams. And the flow meter may be used to determine set points for the various flow controlling devices. In one embodiment, set points are determined by dividing a total measured flow rate by the number of the gas streams or reactors being used. Further, one or more control loops may be established between the flow meter and the flow controlling devices. To achieve additional efficiencies, more than one process gas may be combined and directed to the flow meter. In further embodiments, a second gas flow system can be combined with the first system, such as to feed an additional process gas to the reactors without mixing the additional process gas with the other process gas or gases from the first system prior to entry into the reactors. Additional gas flow systems may be added as needed.

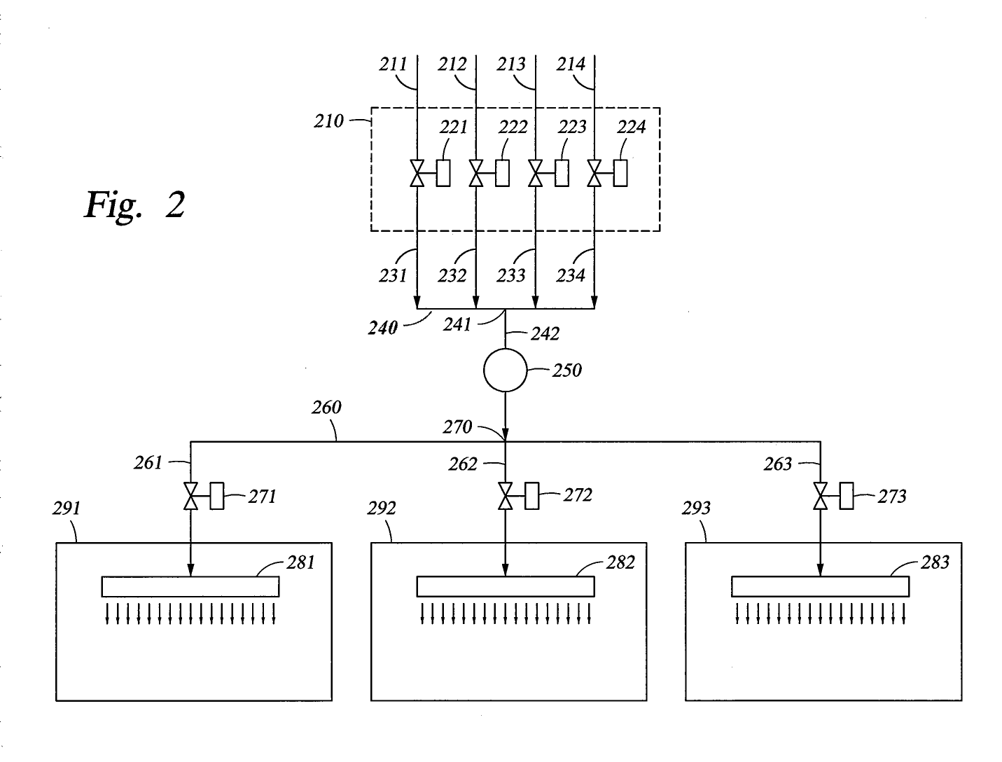

FIG. 2 illustrates a further embodiment, for a gas mass flow balance system. A gas panel 210 is provided, which may comprise a common gas panel known in the art. In this example, the gas panel is illustrated with first, second, third and fourth gas supply lines 211, 212, 213 and 214. The gas supply lines may come from gas tanks (not shown) in fluid connection with the gas panel 210. Example gases may comprise nitrogen, hydrogen, oxygen, silane and other process gases known in the art. It should be appreciated that more gas supply lines may be provided for other types of process gases. Gas panel 210 further comprises a mass flow controller 221, 222, 223 and 224 for each of the gas supply lines 211-214, respectively. Thus, a first mass flow controller 221 may be used to control the supply of a first process gas, a second mass flow controller 222 may be used to control the supply of a second process gas, a third mass flow controller 223 may be used to control the supply of a third process gas, and a fourth mass flow controller 224 may be used to control the supply of a fourth process gas. Additional flow control devices for additional gas supply lines may be used as desired. In the alternative, other piping and/or valve assemblies for flow control may be substituted for mass flow controllers 221-224.

From the gas panel 210, the first process gas passes from the first mass flow controller 221 through a first gas panel outlet line 231 into a first piping assembly 240. Similarly, the second process gas passes through a second gas panel outlet line 232 into the first piping assembly 240, the third process gas passes through a second gas panel outlet line 233 into the first piping assembly 240, and the fourth process gas passes through a fourth gas panel outlet line 234 into the first piping assembly 240. In the first piping assembly 240, process gas or gases received from the gas panel and directed to a total mass flow rate meter (MFM) 250. Thus, if only one process gas is being supplied from the gas panel 210, then only one gas will be directed to the total MFM 250. If more than one process gas is being supplied from the gas panel 210, then the process gases are combined in the first piping assembly 240 and the total flow is directed to the total MFM 250. In one embodiment, the first piping assembly 240 comprises a common manifold 241, in which the different gas panel outlet lines converge to form a combined gas stream, which is routed to a single main supply line 242. In another embodiment, the first piping assembly comprises one or more piping sections that converge into the single main supply line 242. The main supply line 242 may then be directed to the total MFM 250. In this manner, various combinations of process gases may be routed from a single gas panel to a single main supply line mass flow rate meter.

The mass flow meter 250 may be used to measure total mass flow of all gases coming from the first piping assembly 240 through the main supply line 242. Gases coming from the MFM 250 may be directed to a second piping assembly 260. The second piping assembly 260 allows the gas flow to split (into equal portions) to be fed into each of multiple reactors. In FIG. 2, the second piping assembly 260 allows the total gas mass flow to split into first, second and third branch supply lines 261, 262 and 263. Each branch supply line includes a mass flow control device for that specific branch line. Thus, the first branch supply line 261 includes a first mass flow control device 271, the second branch supply line 262 includes a second mass flow control device 272, and the third branch supply line 263 includes a third mass flow control device 273. In one embodiment, the flow control devices are mass flow controllers. In another embodiment, the flow control devices are control valves, which may open or close by specified amounts or percentages.

In order to split the total gas flow from the mass flow meter 250 into even portions for each branch line, the second piping assembly 260 may also include a flow splitting device 270. In some embodiments, the flow splitting device 270 may comprise a flow splitting manifold with a separate outlet for each branch line. In other embodiments, one or more piping sections may be configured that has an outlet for each branch line. Fittings or orifices or other devices affecting pressure drop or flow may be added or removed from one or more lines so that gas flow is equalized across the different branch lines feeding the reactors.

For the example depicted in FIG. 2, the first, second and third flow control devices 271, 272 and 273 are first, second and third mass flow controllers (MFCs), which each control the amount of gas that passes through it. Commonly provided set points may be used to provide this control. Thus, gas flows through the first MFC 271, which controls the gas supply rate by mass, and flows downstream to the first reactor 291. In the embodiment illustrated in FIG. 2, gas flows from the first MFC 271 into a first showerhead 281 and on into the first reactor 291. Likewise, gas flows from the second MFC 272 into a second showerhead 282 and on into the second reactor 292. Additionally, gas flows from the third MFC 273 into a third showerhead 283 and on into the third reactor 293. The reactors may be plasma reactors. In one embodiment, the reactors are CVD reactors. In some embodiments, the reactors are parallel reactors that are operated at the same time under the same process conditions. It should be appreciated that additional branch supply lines and flow control devices can be utilized for additional reactors in the same manner shown. For example, the second piping assembly 260 (or the flow splitting device 270) can be configured to split the total gas flow into a fourth branch line (not shown), which can direct the gas supply to a fourth flow control device (such as a fourth MFC), and on into a fourth reactor.

To actively control the amount of gas flow to each reactor, the total flow reading from MFM 250 (or a signal indicative of total flow) may be used to control the multiple MFCs 271, 272, 273, etc. Since the total gas flow is split into equal portions for each branch supply line, the total flow reading may be divided by the number of branch supply lines (or the number of MFCs or the number of reactors being fed) to determine a set point for each MFC. The set point may be supplied to each MFC to provide an active set point value. Each MFC may then use the 1/n set point of mass flow to actively control the flow of gas to each reactor. In some embodiments, a single set point is calculated and the single set point is input into each MFC. In other embodiments, first, second, third and/or fourth set points are calculated for the respective MFCs. Additional set points may be added for additional MFCs feeding additional reactors. In further embodiments, a control loop may be established between the MFM 250 and each of the branch MFCs. In some embodiments, first, second, third and/or fourth control loops may be established between the MFM 250 and each of the respective branch MFCs. Additional control loops may be established for any additional reactors. And a control system may be used to operate the control loops electronically or through a computer interface.

In some embodiments, the MFM 250 may produce an analog output signal. This signal may be converted into one or more set points. In further embodiments, the analog output signal may be converted into one or more digital set points.

Gases used in the gas panel 210 may be selected for flow based on compatibility when mixing. In one embodiment, gases are only provided to the gas panel that may be mixed prior to introduction in a reactor without adverse process results. If an additional gas or gases need to be supplied to the reactor that cannot be mixed with the other process gases due to adverse process results, a second gas supply system with a second individual mass flow meter coupled to secondary branch supply line mass flow controllers may supply the additional gas or gases into each of the reactors. Thus, the first and second gas supply systems may be operated together to introduce various process gases.

In another embodiment, process gases which are not desirable to mix before entering the reactors may be provided to the same gas panel. However, only process gases that are compatible for mixing are combined during operation. This selection of gases may be performed by a control system to ensure the correct selection of gases to combine. If process gases which are not desirable to mix must enter the reactors at the same time, one or more of the non-compatible process gases may be supplied separately into the reactors, such as by a separate secondary mass flow meter coupled to a secondary branch line mass flow controller. In another embodiment, piping may be configured to operate with the single mass flow rate meter until two or more non-compatible process gases need to be added at the same time. In that case, the first piping assembly 240 may be configured with valves that can route one of the non-compatible process gases to a separate secondary mass flow meter coupled to a series of secondary branch line mass flow controllers for the multiple reactors, respectively. Additional mass flow meters and branch line mass flow controllers may be used to control the flow rate of each additional non-compatible process gases. A control system coupled to control valves may determine when to direct a process gas to a second mass flow meter or a second system.

In one example, nitrogen is available to be supplied through the first gas supply line 211, hydrogen is available to be supplied through the second gas supply line 212, oxygen is available to be supplied through the third gas supply line 213, and silane (SiH₄) is available to be supplied through the fourth gas supply line 214. However, it may not be desirable to mix oxygen with silane prior to introduction into the reactors. Accordingly, the control system would not supply oxygen into the first piping assembly 240 at the same time as silane. In the alternative, oxygen and silane could each be supplied by a separate piping system that each has its own mass flow meter providing set point control to branch line mass flow controllers.

In another example, it may be desired to be combine silane with ammonia in a reactor to produce a silicon nitride film. However, mixing silane with ammonia prior to introduction into the reactors could cause the silane molecules to break down and release silicon and hydrogen ions prematurely. To avoid premature reactions, silane and ammonia would need to be added by separate first and second gas supply (piping) systems that each has its own mass flow meter. A first MFM would provide set point control to a first series of branch MFCs for the multiple reactors, respectively. A second MFM would provide set point control to a second series of branch MFCs for the multiple reactors, respectively. First and second gas panels could also be used to supply the first and second gas supply piping systems.

In a specific gas panel, additional gas supply lines may be utilized for other process gases. For some embodiments, an inert gas such as argon may be added as a carrier gas. Other oxygen or nitrogen containing gases may also be used, such as water vapor or ammonia, respectively. Other silicon containing gases may also be used, depending on the desired deposition process or film composition. In other embodiments, one or more etching gases may be used in a gas panel. In further embodiments, dopant containing gases may be used.

In some embodiments, the arrangement of a single mass flow meter, coupled to a series of branch line mass flow controllers, may be applied to separate individual plasma sources for multiple reactors. In this case, external plasma sources may be used. In one embodiment, four plasma sources would be used with a single mass flow meter determining set points for four branch line mass flow controllers that each feed a separate reactor.

While the foregoing is directed to embodiments, other and further embodiments may be devised without departing from the basic scope thereof, and the scope thereof is determined by the claims that follow.

1. A first gas supply system for multiple substrate processing chambers, comprising:
one or more gas supply lines configured to supply one or more process gases to multiple reactors;
a main supply line supplied by the one or more gas lines;
a main supply line mass flow measuring device positioned to measure a parameter indicative of total mass flow rate of the one or more process gases in the main supply line;
a series of branch lines supplied by the main supply line, wherein at least one branch line supplies the one or more process gases to each reactor; and
a series of branch line mass flow controllers, wherein there is at least one mass flow controller positioned to control the mass flow of the one or more process gases through each branch line according to one or more set points derived from the measured parameter of the main supply line mass flow measuring device.

2. The system of claim 1, wherein the one or more gas supply lines comprises a first plurality of gas supply lines that is each configured to supply a process gas such that a plurality of process gases are available to be delivered to the multiple reactors.

3. The system of claim 2, further comprising a gas panel supplying the first plurality of gas supply lines.

4. The system of claim 3, further comprising:
a common manifold supplied by the first plurality of gas supply lines and supplying the main supply line, wherein the first plurality of process gases are combined in the common manifold into a total gas flow in the main supply line; and
a splitting manifold supplied by the main supply line, wherein the total gas flow of the first plurality of process gases is split about equally to supply each of the branch lines.

5. The system of claim 3, further comprising a series of showerheads such that one showerhead is contained within each reactor that is supplied by at least one branch line, wherein the multiple reactors are chemical vapor deposition reactors configured to operate in parallel.

6. The system of claim 3, wherein the main supply line mass flow measuring device comprises a mass flow meter that determines the total mass flow rate, and the one or more set points for the branch line mass flow controllers are determined by dividing the total mass flow rate by the number of reactors being fed from the series of branch lines.

7. The system of claim 6, further comprising one or more control loops established between the main supply line mass flow measuring device and the branch line mass flow controllers.

8. The system of claim 7, wherein the one or more set points are determined by dividing the total gas flow by either the number of reactors, or the number of branch lines or the number of mass flow controllers.

9. The system of claim 8, wherein there are three reactors, and the number of branch lines and the number of mass flow controllers are equal to the number of reactors.

10. The system of claim 9, wherein there are four reactors.

11. The system of claim 3, further comprising a second gas supply system set up to feed one or more additional process gases to the multiple reactors being fed by the first gas supply system, without mixing a second set of the one or more additional process gases from the second gas supply system with the one or more process gases from the first plurality of gas supply lines, wherein the second system comprises:
one or more secondary gas supply lines configured to supply the second set of one or more of the additional process gases to the multiple reactors;
a secondary main supply line supplied by the one or more secondary gas supply lines;
a secondary flow measuring device configured and positioned to measure a secondary total mass flow in the secondary main supply line;
a series of secondary branch lines supplied by the secondary main supply line, wherein at least one secondary branch line supplies gas flow flow to each of the multiple reactors; and
a series of secondary branch line mass flow controllers, wherein at least one secondary flow controller controls the mass flow to each of the series of secondary branch lines according to a secondary set point determined by dividing the mass flow measured by the secondary mass flow measuring device and dividing it by the number of reactors being fed by the series of secondary branch lines.

12. A gas supply control system for multiple parallel chemical vapor deposition reactors, comprising at least a first gas supply system comprising:
a gas panel having a plurality of gas outlet lines, wherein each gas outlet line is configured to supply one of a plurality of process gases to multiple reactors;
a main supply line supplied by the plurality of gas outlet lines, forming a combined total gas flow;
a mass flow meter positioned to measure a combined total gas flow rate of the combined total gas flow in the main supply line;
a first, a second and a third branch line, each supplied by the main supply line;
a first branch mass flow controller controlling the mass flow rate in the first branch line, the first branch line supplying a first reactor of the multiple reactors, a second branch mass flow controller controlling the mass flow rate in the second branch line supplying a second reactor of the multiple reactors, and a third branch mass flow controller controlling the mass flow rate in the third branch line supplying a third reactor of the multiple reactors; and
one or more control loops established between the main supply line mass flow meter and the first, second and third branch mass flow controllers.

13. The gas supply control system of claim 12, wherein the control loop is wired to determine a set point for each of the first, second and third branch mass flow controllers based on dividing the combined total gas flow rate by the number of reactors in use, and further comprising a computer control unit.

14. The gas supply control system of claim 13, further comprising:
a fourth branch line supplied by said main supply line; and
a fourth branch mass flow controller controlling the mass flow rate in the fourth branch line supplying a fourth reactor of the multiple reactors, wherein a control loop is established between the main line mass flow meter and the fourth branch mass flow controller.

15. The gas supply control system of claim 14, further comprising a second gas supply system comprising:
one or more secondary gas outlet lines configured to supply one or more secondary process gases, respectively;
a secondary main supply line supplied by the one or more secondary gas outlet lines, forming a total combined secondary gas flow;
a secondary main supply line mass flow meter measuring a secondary main supply line mass flow rate of the total secondary gas flow;
first, second, third and fourth secondary branch lines supplied by said secondary main supply line;
a secondary first branch mass flow controller controlling the mass flow rate in the secondary first branch line supplying the first reactor of said multiple reactors, a secondary second branch mass flow controller controlling the mass flow rate in the secondary second branch line supplying the second reactor of a said multiple reactors, and a secondary third branch mass flow controller controlling the mass flow rate in the secondary third branch line supplying the third reactor of said multiple reactors, a secondary fourth mass flow controller controlling the mass flow rate in the secondary fourth branch line supplying the fourth reactor of said multiple reactors; and
one or more control loops established between the secondary main supply line mass flow meter and the secondary first, second, third and fourth mass flow controllers.

16. A method of controlling the flow of process gases to multiple parallel reactors used for solar cell production, comprising the steps of:
supplying one or more process gases to a piping assembly, wherein the piping assembly is arranged so that, when more than one of the process gases are supplied, the plurality of process gases are combined;
measuring a total gas flow rate of the combined process gases, by using a total gas mass flow meter;
approximately equally splitting the total gas mass flow rate into three or more branch gas supply lines by operating a control system that uses the signal generated by the total gas mass flow meter to determine a set point for each of multiple branch supply line gas mass flow rate controllers, wherein the total mass gas flow rate is split into multiple separate gas streams of approximately equal amounts, and each of the separate branch supply gas streams is controlled by one of the multiple branch gas mass flow rate controllers to regulate the gas mass flow rate fed into one of multiple parallel reactors; and
operating each of the multiple parallel reactors.

17. The method of claim 16, wherein the step of operating each of the multiple parallel reactors comprises conducting a chemical vapor deposition process on solar cells within the multiple reactors.

18. The method of claim 16, wherein four reactors are operated.

19. The method of claim 18, further comprising the steps of:
supplying one or more additional process gases into an additional piping assembly, wherein the additional piping assembly is arranged so that, when more than one of the additional process gases are supplied, the plurality of additional process gases are combined; and
measuring the combined total mass flow rate and generating an additional signal representative of a total additional gas mass flow rate of the one or more additional process gases, by using an additional gas mass flow meter,
wherein the step of operating the control system further comprises using the additional signal generated by the additional gas mass flow meter to determine a set point for each of multiple additional gas mass flow controllers, wherein the total additional gas mass flow coming from the mass flow meter is split into multiple separate additional branch gas streams, and each of the separate additional gas streams is supplied to one of the multiple additional gas mass flow controllers, and each of the multiple additional gas mass flow controllers regulates the flow of the additional gas stream into approximately equal amounts to supply one of multiple parallel reactors.

20. The method of claim 16, wherein the process gases comprise plasmas from an external plasma source.
